(19) United States
(12) Patent Application Publication
(10) Pub. No.: US 2008/0160369 A1
(43) Pub. Date: Jul. 3, 2008

(54) FUEL CELL DEVICE

(76) Inventors: CHUN-CHIN TUNG, Chupei (TW); Wen-Hsing Chang, Chupei (TW)

Correspondence Address: G. LINK CO., LTD., 3550 BELL ROAD, MINOOKA, IL, 60447, US

(21) Appl. No.: 11/967,076

(22) Filed: Dec. 29, 2007

(30) Foreign Application Priority Data
Jan. 3, 2007 (TW) 096100192

(51) Int. Cl. H01M 8/04

(52) U.S. Cl. 429/22

(57) ABSTRACT

The present invention relates to a fuel cell device applied in an electronic device. The electronic device has a power supply unit to supply power to it. The fuel cell device comprises a fuel cell, a regulator unit, a microprocessor unit an auxiliary unit and a power loop device. The regulator unit converts the DC voltage of power output by the fuel cell. The microprocessor unit controls the operation of the fuel cell device and carries out computing needed for its operation. The auxiliary unit supports the operation of the fuel cell. The power loop device selects the power output by the fuel cell device to the electronic device, or power input from the electronic device to the fuel cell device.

### FIELD OF THE INVENTION

The present invention relates to a fuel cell device, more particularly a kind of fuel cell that uses the power supply unit of an electronic device to activate its internal loading, and takes over the power supply to the electronic device after activation.

### BACKGROUND OF THE INVENTION

Conventional fuel cells uses hydrogen and oxygen to undergo electrochemical reaction and have become an emerging energy alternative that supplies electric power. If a fuel cell has not been used for a considerable period of time, the surroundings of its membrane electrode assembly become less moist. Thus each time a fuel cell is activated, the fuel cell has to be hydrated to moisturize its membrane electrode assembly so fuel cell can undergo normal electrochemical reaction and produce the rated output power. Thus before a fuel cell competes its activation, power is needed for its internal loading, including, for example, the operations of its microprocessor unit and fuel control unit to facilitate the hydration and activation of fuel cell. A fuel cell typically relies on an internal secondary cell to supply the power needed by its internal loading. But adding a secondary cell to a fuel cell will bulk up the system, which is adverse to the portability of the fuel cell and increases its cost.

In light of the drawbacks of conventional fuel cells, the inventor aims to develop a product that meets the current needs.

### SUMMARY OF THE INVENTION

The primary object of the invention is to provide a Fuel cell device, which, through the working of a microprocessor unit and a power loop device, chooses power input from an external electronic device or power output by the fuel cell.

Another object of the invention is to provide a fuel cell device which uses the power supplied by an external electronic device to carry out its hydration.

In the fuel cell device provided by the invention, the fuel cell supplies the power needed by the internal microprocessor, auxiliary unit and the electronic device after it completes the hydration.

To achieve the aforesaid objects, the present invention provides a fuel cell device applied in an electronic device. The electronic device has a power supply unit to supply power to it. The fuel cell device comprises a fuel cell, a regulator unit, a microprocessor unit, an auxiliary unit and a power loop device. The regulator unit converts the DC voltage of power output by the fuel cell. The microprocessor unit controls the operation of the fuel cell device and carries out computing needed for its operation. The auxiliary unit supports the operation of the fuel cell. The power loop device selects the power output by the fuel cell device to the electronic device, or power input from the electronic device to the fuel cell device.

The objects, features and effects of the invention are described in detail below with embodiments in reference to the accompanying drawings.

### BRIEF DESCRIPTION OF THE DRAWINGS

FIG. 1 is the component diagram of a fuel cell device according to an embodiment of the invention; and

FIG. 2 is a diagram showing partial components of a fuel cell device according to an embodiment of the invention.

### DETAILED DESCRIPTION OF THE INVENTION

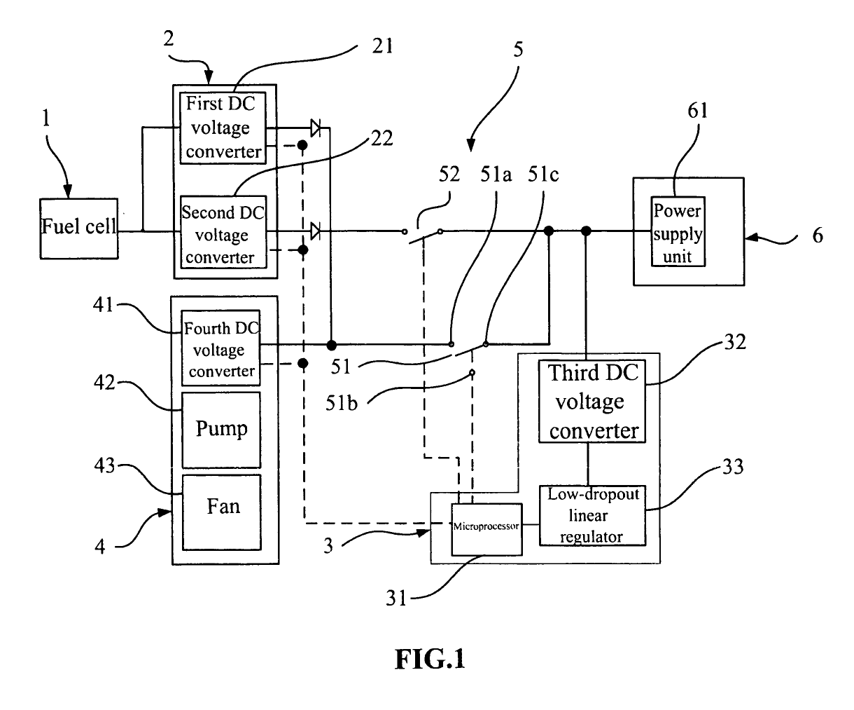

FIG. 1 is the component diagram of a fuel cell device according to an embodiment of the invention. The fuel cell device of the invention comprises a fuel cell (1), a regulator unit (2), a microprocessor unit (3), an auxiliary unit (4) and a power loop device (5). The fuel cell device is electrically connected to an electronic device (6) via the power loop device (5) such that the fuel cell device can transmit power to the electronic device (6) or the power of the electronic device (6) can be transmitted to the fuel cell device.

The electronic device (6) has a power supply unit (61). The power supply unit (61) contains a secondary cell, an external power source, and a circuit for power switch to supply power to the electronic device (6). The electronic device (6) can choose to use the secondary cell in the electronic device or the external power. In an embodiment, the electronic device (6) is a notebook computer. The secondary cell in its power supply unit (61) is a lithium battery, while its external power source is the city power grid or the fuel cell device of the invention. The electronic device (6) can choose to use the secondary cell or external power, and choose to use the external power for charging the secondary cell. Moreover, the electronic device (6) can, through internal circuit control (not shown in the figure and not a key element of the invention) to combine the power supply unit (61) and the fuel cell device of the invention into a hybrid power application system. In addition, when the fuel cell device chooses to activate the fuel cell (1), the power supply unit (61) can supply power to the microprocessor unit (3) and the auxiliary unit (4) of the fuel cell device to carry out the hydration of fuel cell.

In the fuel cell device of the invention, the fuel cell (1) contains catalyst, and can undergo electrochemical reaction using hydrogen-rich fuel and oxygen fuel and output power. The regulator unit (2) is electrically connected to the fuel cell (I) and comprises a plurality of DC voltage converters to convert the DC voltage of power output by the fuel cell (1). The microprocessor unit (3) contains a microprocessor (31) and is electrically connected to the regulator unit (2), the auxiliary unit (4), and the power loop device (5) such that the microprocessor (31) can control the operation of the fuel cell device and carry out computing needed for its operation. The auxiliary unit (4) supplies fuel and controls the operating conditions of the fuel cell (1) so as to support the operation of the fuel cell (I). The power loop device (5) is a circuit device, which, through the control of the microprocessor (31) in the microprocessor unit (3), chooses the power output by the fuel cell device to the electronic device (6) or choose the power input from the electronic device (6) to the fuel cell device. Thus the fuel cell (1) can convert its output power into a predetermined voltage for output via the regulator unit (2), and then provide the electric signal to the microprocessor unit (3), the auxiliary unit (4), and the electronic device via the power loop device (5). The power loop device (5) can also choose via the microprocessor unit (3) to supply the power from the power supply unit (61) of the electronic device (6) to the microprocessor unit (3) and the auxiliary unit (4).

The respective DC voltage converters in the regulator unit (2) is confined to having the end electrically connected to the fuel cell (1) for power input and the other end for power output.

More specifically, the regulator unit (2) further contains a first DC voltage converter (21) and a second DC voltage converter (22). The first DC voltage converter (21) and the second DC voltage converter (22) respectively convert the voltage produced by the fuel cell (1) into stable voltage V1 and voltage V2 for use respectively by the electronic device (6) and the auxiliary unit (4). The microprocessor unit (3) further contains a third DC voltage converter (32), the third DC voltage converter (32) converting the voltage inputted into the microprocessor unit (3) into a voltage V3 needed by the microprocessor (31) of the microprocessor unit (3). The auxiliary unit (4) further contains a fourth DC voltage converter (41), a pump (42) and a fan (43). The fourth DC voltage converter (4!) converts the voltage inputted into the auxiliary unit (4) into a voltage V4 needed by the elements of the auxiliary unit (4), and the pump (42) and the fan (43) respectively coordinates with the operation of the fuel cell (I) to control the fuel supply or the operating temperature of the fuel cell (1). The loop device (5) further contains a plurality of electric switches, the electric switches being electrically connected to the microprocessor (31) in the microprocessor unit (3) such that the microprocessor (31) can select the on or off-state of those electrical switches so as to control the on-state path of the loop device (5) and the direction of power supply.

The plurality of electric switches in the loop device (5) contains a first electric switch (51) and a second electric switch (52). The first electric switch (51) is electrically connected to the first DC voltage converter (21) and the fourth DC voltage converter (41) at one end, and electrically connected to the power supply unit (61) of the electric device (6) at the other end. The second electric switch (52) is electrically connected to the second DC voltage converter (22) at one end and electrically connected to the third DC voltage converter (32) of the microprocessor unit (3) and the power supply unit (61) of the electronic device (6) at the other end.

The microprocessor unit (3) further contains a low-dropout linear regulator (33) such that the power inputted into the microprocessor unit (3) undergoes DC voltage conversion first by the third DC voltage converter (32) and then by the low-dropout linear regulator (33) to obtain more stable voltage for use by the microprocessor (31).

In the fuel cell device according to the invention, the power from the power supply unit (61) is transmitted to the third DC voltage converter (32) for conversion into a predetermined voltage V3 for use by the microprocessor (31). Upon receiving the command to activate the fuel cell (1), the microprocessor (31) chooses to turn on the first electric switch (51) and turn off the second electric switch (52), and chooses to turn on the fourth DC voltage converter (41). As such, power from the power supply device (61) passes through the fourth DC voltage converter (41) and is converted into a voltage V4 for use by the auxiliary unit (4) and for controlling the operation of the pump (42) and fan (43) via the microprocessor unit (3) to carry out the hydration of fuel cell (I). When the fuel cell (1) is hydrated and begins to produce power under normal operation, the microprocessor (31) of the microprocessor unit (3) chooses to turn off the first electric switch (51) and turn on the second electric switch (52), and chooses to activate the first DC voltage converter (21) and the second DC voltage converter (22). As such, the power from the fuel cell (I) is respectively converted into voltage V1 through the first DC voltage converter (21) and voltage V2 through the second DC voltage converter (22). The power of output voltage V1 from the first DC voltage converter (21) is transmitted to the fourth DC voltage converter (41) where it is converted into output voltage V4 for use by the auxiliary unit (4). The power of output voltage V2 from the second DC voltage converter (22) is transmitted respectively to the microprocessor unit (3) and the power supply unit (61) of the electronic device (6), and the third DC voltage converter (32) again the power into output voltage V3 for use by the microprocessor unit (3). The power supply unit (61) distributes the power to the electronic device (6) or to its secondary cell for charging.

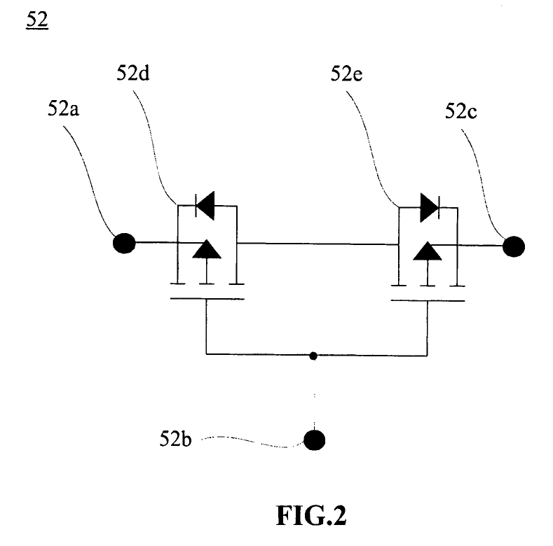

Referring to FIG. 2 which is a diagram showing partial components of a fuel cell device according to the invention, the first electric switch (51) contains a first terminal (51a), a second terminal (51b), a third terminal (51c), a first switch element (51d), and a second switch element (51e). The first switch element (51d) and the second switch element (51e) are reversely arranged and together form an electric series. The two ends of the serially connected first switch element (51d) and the second switch element (51e) respectively form the first terminal (51a) and the third terminal (51c). The first terminal (51a) is electrically connected to the first DC voltage converter (21) and the fourth DC voltage converter (41). The third terminal (51c) is electrically connected to the power supply unit (61) of the electronic device (6). The second terminal (51b) is electrically connected to the microprocessor unit (3) and the gate of the first switch element (51d) and the second switch element (51e), where the microprocessor (31) controls its on/off-state based on the operating procedure of the fuel cell. The circuit connection of two transistors, i.e. the first switch element (51d) and the second switch element (51e) avoid the problem of current leak commonly seen in the use of one transistor alone.

The present invention has been disclosed in detail in the examples. However the examples should not be construed as a limitation on the actual applicable scope of the invention, and as such, all modifications and alterations without departing from the spirits of the invention and appended claims shall remain within the protected scope and claims of the invention.

What is claimed is:

1. A fuel cell device used in an electronic device, the electronic device having a power supply unit for supply power to the electronic device, and the fuel cell device comprising:
a fuel cell;
a regulator unit being electrically connected to the fuel cell and containing at least a DC voltage converter, where the end of each DC voltage converter electrically connected to the fuel cell being for power input and its other end being for power output;
a microprocessor unit including a microprocessor, the microprocessor controlling the operation of the fuel cell device and carrying out computing needed for its operation;
an auxiliary unit for fuel supply and controlling the operating conditions of the fuel cell; and
a power loop device being an circuit device having a plurality of electrically connected channels and electrically connected to the regulator unit, the microprocessor unit and the auxiliary unit;
wherein the microprocessor unit chooses the electrically connected channel of the power loop device and chooses either state of power from the fuel cell device being transmitted to the microprocessor unit, the auxiliary unit and the electronic device or the power from the electronic device being transmitted to the microprocessor unit and the auxiliary unit.

2. The fuel cell device according to claim 1, wherein the regulator unit contains a first DC voltage converter and a second DC voltage converter.

3. The fuel cell device according to claim 2, wherein the power loop device further comprises a first electric switch and a second electric switch, the first electric switch being electrically connected to the first voltage converter and the auxiliary unit at one end, and being electrically connected to the power supply unit of the electronic device and the microprocessor unit at the other end: the second electric switch being electrically connected to the second DC voltage converter at one end and being electrically connected to the microprocessor unit and the power supply unit of the electronic device at the other end;
wherein the microprocessor of the microprocessor unit being electrically connected to the first electric switch and the second electric switch, and choosing the on or off of the first electric switch and the second electric switch.

4. The fuel cell device according to claim 3, wherein the microprocessor unit further contains a third DC voltage converter, the end of the second electric switch electrically connected to the electronic device being simultaneously electrically connected to the third DC voltage converter of the microprocessor unit.

5. The fuel cell device according to claim 4, wherein the first electric switch contains a first terminal, a second terminal a third terminal, a first switch element, and a second switch element, the first switch element and the second switch element being reversely arranged and together forming an electric series, the two ends of the serially connected first switch element and the second switch element respectively forming the first terminal and the third terminal, the first terminal being electrically connected to the first DC voltage converter and the fourth DC voltage converter, the third terminal being electrically connected to the power supply unit of the electronic device, the second terminal being electrically connected to the microprocessor of the microprocessor unit and the gate of the first switch element and the second switch element.

6. The fuel cell device according to claim 5, wherein the switch element is an electronic component selected from the group consisting of transistor switches and MOS switches.

7. The fuel cell device according to claim 3, wherein the electric switch is an electronic component selected from the group consisting of transistor switches and MOS switches.

8. The fuel cell device according to claim 3, wherein the auxiliary unit further comprises a fourth DC voltage converter, the fourth DC voltage converter being electrically connected to the power loop device, converting the inputted power to specific voltage and supplying power to the interior of the auxiliary unit.

9. The fuel cell device according to claim 8, wherein the fourth DC voltage converter and the first DC voltage converter are electrically connected to the same end of the first electric switch, the other end of the first electric switch being electrically connected to the third DC voltage converter of the microprocessor unit and the power supply unit of the electric device.

10. The fuel cell device according to claim 9, wherein the microprocessor unit further contains a low-dropout linear regulator, the power inputted into the microprocessor unit undergoing two stages of DC voltage conversion by the third DC voltage converter and then by the low-dropout linear regulator.

11. The fuel cell device according to claim 4, wherein the control steps of the microprocessor unit comprising:
the power from the power supply unit being transmitted to the third DC voltage converter and supplied to the microprocessor unit until the microprocessor receives the fuel cell activation command;
choosing on-state for the first electric switch, off-state for the second electric switch, and on-state for the fourth DC voltage converter; and
controlling the operations of pump and fan in the auxiliary unit to carry out the hydration of fuel cell;
when the fuel cell outputs power normally, choosing off-state for the first electric switch, on-state for the second electric switch, and choosing the activation of the first DC voltage converter and the activation of the second DC voltage converter;
the power output by the first DC voltage converter being transmitted to the fourth DC voltage converter for use by the auxiliary unit; and
the power output by the second DC voltage converter being transmitted to the third DC voltage converter and the power supply unit of the electronic device for use by the microprocessor unit and the power supply unit.

12. The fuel cell device according to claim 1, wherein the power supply unit of the electronic device contains a secondary cell.

13. The fuel cell device according to claim 1, wherein the power supply unit of the electronic device contains an external power source.

14. The fuel cell device according to claim 1, wherein the auxiliary unit further comprises a pump.

15. The fuel cell device according to claim 1, wherein the auxiliary unit further comprises a fan.
